(19) United States
(12) Patent Application Publication
(10) Pub. No.: US 2016/0318107 A1
(43) Pub. Date: Nov. 3, 2016

(54) Clamping Device

(71) Applicant: Narr Beteiligungs GmbH, Kirchheim/Teck (DE)

(72) Inventor: Peter Mauch, Konigsheim (DE)

(21) Appl. No.: 14/698,878

(22) Filed: Apr. 29, 2015

(51) Int. Cl. B23B 31/20; B23Q 3/06; B23B 31/39

(52) U.S. Cl. CPC B23B 31/20; B23B 31/39; B23Q 3/067; B23B 2231/2078; B23B 2240/04

(57) ABSTRACT

The invention relates to a clamping device (1) for clamping a workpiece and is comprised of a chuck (2) and a collet (3) situated in the chuck (2). A bayonet closure is provided via which the collet (3) can be secured in the chuck (2) or released from it without a tool; the collet (3) can be moved between a clamped position and a release position against a fixed part of the chuck (2). At least one locking element (23) is situated in the fixed part of the chuck (2) that secures the bayonet closure against a release in the clamped position and that releases the bayonet closure for actuation in the release position.

### CROSS-REFERENCE TO RELATED APPLICATIONS

This application claims the benefit under 35 USC 119 of European Application No. EU 14166299.9 filed on Apr. 29, 2014; that application is incorporated by reference herein in its entirety.

### BACKGROUND

The invention relates to a clamping device.

Clamping devices of this type serve to clamp a workpiece in place in general. The clamping device has a chuck and a collet situated in the chuck. The collet serves to secure the respective workpiece. To this end, the collet is preferably actuated via a connecting rod that is, in particular, actuated via a drive unit, meaning pushed. The collet is advantageously made up of several collet segments for this that can carry out positioning movements and thus clamp the workpiece that is to be held and also release it again.

If the clamping device is to be used to clamp diverse types of workpieces, the collet on the chuck has to be replaced in the clamping device. A problem with known clamping devices is that special auxiliary tools are required for this that have to be used to release the collet that is to be replaced in the chuck so that it can be removed from the chuck. The auxiliary tool has to be used in a corresponding way to fix the new collet in place in the chuck.

The use of auxiliary tools means that there is undesired additional construction effort to build the clamping device. A further drawback is that the auxiliary tools are loose parts that have to be stored separately. The auxiliary tools are then frequently not available when a collet has to be replaced in the chuck, so additional effort arises to look for or procure the auxiliary tool.

A clamping device is known from DE 20 2013 103 278 that serves to clamp a workpiece, and it has a chuck and a collet situated in the chuck. The collet can be secured in the chuck or released from it without a tool by means of a bayonet closure.

### SUMMARY

The invention relates to a clamping device (1) for clamping a workpiece and is comprised of a chuck (2) and a collet (3) situated in the chuck (2). A bayonet closure is provided via which the collet (3) can be secured in the chuck (2) or released from it without a tool; the collet (3) can be moved between a clamped position and a release position against a fixed part of the chuck (2). At least one locking element (23) is situated in the fixed part of the chuck (2) that secures the bayonet closure against a release in the clamped position and that releases the bayonet closure for actuation in the release position.

### DETAILED DESCRIPTION

The invention is based on the problem of providing a clamping device of the type mentioned at the outset that has a high level of functionality with low construction effort.

The elements of claim 1 are specified to solve this problem. Advantageous embodiments and useful design developments of the invention are described in the sub-claims.

The clamping device as per the invention serves to clamp a workpiece and comprises a chuck and a collet situated in the chuck. A bayonet closure is provided via which the collet can be secured in the chuck or released from it without a tool; the collet can be moved between a clamped position and a release position against a fixed part of the chuck. At least one locking element is situated in the fixed part of the chuck that secures the bayonet closure against a release in the clamped position and that releases the bayonet closure for actuation in the release position.

An important advantages of the clamping device as per the invention is that the collet can be mounted in the chuck and, if necessary, removed from the chuck again without the use of additional auxiliary tools. An operator has to merely manually actuate the bayonet closure to fix the collet in place in the bayonet closure.

The bayonet closure forms an integral part of the clamping device and is therefore attached to the clamping device and cannot be lost. An operator can actuate the bayonet closure in a simple and quick way, so the mounting times for an installation or removal of the collet can be kept very short.

It is ensured via the locking element or elements as per the invention that the bayonet closure will remain securely closed during the operation of the clamping device and will not become detached on its own in an uncontrolled fashion when external forces act from the outside. It is therefore ensured that a workpiece fixed in place in the collet will not be able to become detached in an uncontrolled fashion during the operation of the clamping device.

An important advantage of the invention is that no additional adjustments or separate actuations of the clamping device are required by an operator to actuate the locking elements. Rather, the actuation of the locking element or elements is automatic when the collet is put into its release position or clamped position. A high level of operating comfort is therefore achieved, for one thing. Moreover, fail-safe operation of the clamping device is ensured, because the operator does not have to actively actuate the locking element or elements, so faulty operation in that the operator forgets to actuate the locking element or elements is ruled out.

In accordance with an advantageous embodiment, the clamping device has three identical locking elements that are each offset by 120° vis-a-vis one another.

Uniform locking of the bayonet closure is ensured over the circumference of the clamping device because of this rotationally symmetric arrangement.

In accordance with an advantageous embodiment of the invention, the bayonet closure has a manually operated actuation ring and a bayonet ring actively connected to the actuation ring by means of which the collet can be fixed in place on the chuck. At least one locking element locks the bayonet ring against twisting in the clamped position, and at least one locking element unlocks the bayonet ring in the release position.

The bayonet closure is then advantageously locked to the effect that at least one locking element engages in a groove of the bayonet ring in the clamped position.

The locking mechanism that is formed in this way has a simple design structure.

The functional principle of the locking mechanism is that the locking elements are fixed in place in the chuck, preferably in the chuck body of the chuck.

The bayonet closure is then locked in such a way that the bayonet ring with the collet is moved between the release position and the clamped position.

At least one locking element is therefore fed into the groove of the bayonet ring during the clamping of the collet, which is preferably performed by means of a clamping sleeve, in such a way that the bayonet ring is moved vis-a-vis the fixed locking element.

Movement advantageously takes place via rotation of the actuation ring of the bayonet ring between a closed position in which the bayonet ring fixes the collet in place on the chuck and an opened position in which the bayonet ring releases the collect on the chuck. In the closed position of the bayonet ring, the locking element, or each locking element, is only assigned to the respective groove in such a way that the locking element is able to move into the groove when the collet is moved into the clamped position.

If, in contrast, the bayonet ring is not in the closed position, and the collet is moved from the release position into the clamped position, the bayonet ring would press against the locking element and damage or destroy it when the collet is moved into the clamped position because the bayonet ring's groove is not aligned with the locking element.

A safety mechanism is provided to rule this out. The locking element, or each locking element, is spring-mounted with a spring element for this. The locking element is pressed in the direction of the groove of the bayonet ring by means of spring force exerted by the spring element when the bayonet ring is in its closed position in the clamped position of the collet. In the case that the bayonet ring is not in the closed position in the clamped position of the collet, the bayonet ring will press the locking element or each locking element against the spring force into a safety position in the fixed part of the chuck.

Damage to the locking element is avoided when the bayonet ring is in a fixed position, because the pressure exerted by the bayonet ring can consequently be evaded by the spring mounting of the locking element.

### BRIEF DESCRIPTION OF THE DRAWINGS

The invention will be explained with the aid of the drawings below. The following are shown in the figures:

FIG. 1: Partial drawing of the example of the clamping device in accordance with DE 20 2013 103 278 with a bayonet closure to fix the collet in place in a clamping device.

FIG. 2: Component drawing of the components of the clamping device in accordance with FIG. 1.

FIG. 3: Sectional view of the clamping device in accordance with FIG. 1 with an open bayonet closure.

FIG. 4: Sectional view of the clamping device in accordance with FIG. 1 with a closed bayonet closure.

FIG. 5: Example of the clamping device as per the invention.

FIG. 6A: Sectional view of the clamping device in accordance with FIG. 5 in the clamped position of the collet

FIG. 6B: Sectional view of the clamping device in accordance with FIG. 5 in the release position of the collet

### DETAILED DESCRIPTION OF THE PREFERRED EMBODIMENTS

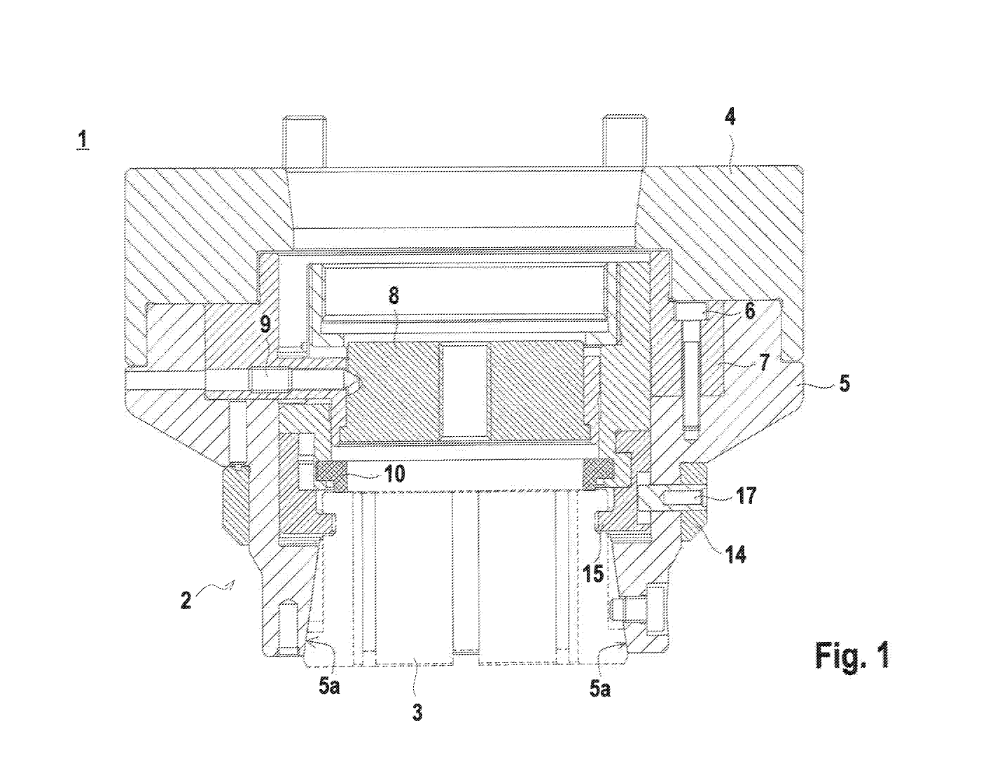

FIGS. 1 to 4 show the clamping device 1 known from DE 20 2013 103 278.

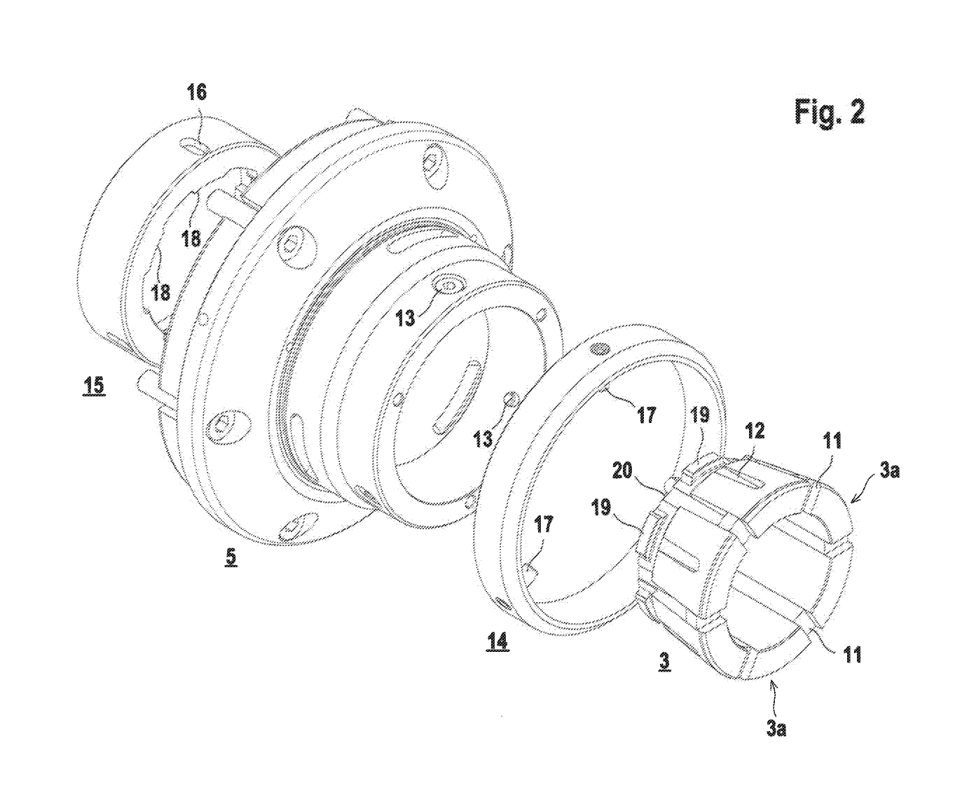

FIG. 1 shows a partial drawing of the clamping device 1, which serves to clamp a workpiece. FIG. 1 shows the chuck 2 and the collet 3 of the clamping device 1. The means for actuating the collet 3 situated in the chuck 2 are not shown; they serve to move the collet 3 and therefore to clamp or release the workpiece, which is likewise not shown. These means can have a drive unit in a familiar way, by means of which a linear movement of a pull rod is effected in the axial direction that serves to actuate the collet 3. Components of the arrangement shown in FIG. 1 are shown in the form of separate parts in FIG. 2.

The chuck 2 of the clamping device 1 is comprised, as evident in FIG. 1, of a chuck flange 4 and a chuck body 5 that is separately shown in FIG. 2. A limit stop holder 7 located between the chuck flange 4 and the chuck body 5 is screwed to the chuck body 5 via cylinder head screws 6.

A replaceable limit stop 8 is situated in the interior of the chuck 2 and fixed in place with a clamping pin 9. The replaceable limit stop 8 forms an exchangeable reference element that provides an adaptation with axial limit stops for various workpieces located in the collet 3.

The chuck body 5 has an opening towards the face, limited by conical jaws 5a into which the collet 3 is inserted. FIG. 1 shows the collet 3 inserted into this opening; connected at the rear edge of the collet, which is inserted into the opening, is a sealing ring 10 situated in the chuck body 5 that protects a locking area, in which the collet 3 is fixed in place in the chuck 2, against the penetration of chips and other impurities.

As evident from FIG. 2, in particular, the collet 3 is comprised of six identically designed collet segments 3a; neighboring collet segments 3a are each connected via elastic elements 11 running in the axial direction of the collet 3. The elastic elements 11 are designed to be molded parts comprised of rubber mixtures. These elastic elements 11 form elastic couplings between the collet segments 3a so that the elastic elements 11 are pressed together when compressive forces are exerted on the external surface of the collet 3 and the collet segments 3a can be pushed together in the radial direction.

The collet is situated in the chuck body 5 in a torsion-proof manner. Grooves 12 running in the axial direction on the surface of the collet 3 are provided as anti-torsion protection. In the instant case, a groove 12 is provided in every collet segment 3a. Cylinder head screws 13 situated in the chuck body 5 engage in these grooves 12; the collet 3 is situated in the chuck body 5 in a torsion-proof way because of that.

The collet 3 is fixed in place in the chuck 2 without tools via a bayonet closure and therefore without any type of auxiliary tools at all. The bayonet closure has an actuation ring 14 situated on the outside of the chuck body 5 that can be actuated by an operator, meaning that it can be rotated. Furthermore, the bayonet closure has a bayonet ring 15 that is concentric to the actuation ring 14 and situated within it; the bayonet ring serves to latch and unlatch the collet 3.

The bayonet ring 15 has grooves 16 in its surface in which pins 17 engage that are situated in the actuation ring 14 and that protrude from its inner surface in the radial direction. A rotational movement of the actuation ring 14 is therefore transferred to the bayonet ring 15.

To fix the collet 3 in place in the chuck 2, the bayonet ring 15 has lugs 18 on a face that project, running in the radial direction, into the hollow area surrounded by the bayonet ring 15. The lugs 18 have an identical design and are separated from one another by spaces in each case. The spaces also have an identical design, so the lugs 18 are equidistantly arranged in the circumferential direction of the bayonet ring 15.

Lands 19 corresponding to the lugs 18 on the bayonet ring 15 are provided in the area of the rear area of the collet 3 leading into the chuck 2 that run in the radial direction on the surface of the collet 3. Six lands 19 are provided in the instant case that are separated by grooves 20. The lands 19 each have an identical design. The grooves 20 between the lands 19 also have an identical design, so the lands 19 are equidistantly arranged in the circumferential direction of the collet 3. The lengths of the lands 19, meaning their extensions in the circumferential direction, are adapted to the lengths of the lugs 18 of the bayonet ring 15.

The bayonet ring 15 can be rotated between an open position and a closed position by rotating the actuation ring 14 by 30°. The bayonet ring 15 is in its open position when the collet 3 is inserted into the chuck 2. The lugs 18 of the bayonet ring 15 are in the areas of the grooves 20 as soon as the collet 3 is inserted up to its target position in the chuck 2, because the bayonet ring 15 is in the open position. The actuation ring 14 is then rotated by 30° until the bayonet ring 15 is in the closed position to lock the collet 3 in the chuck 2. In the closed position, the lugs 18 of the bayonet ring 15 are in contact with the front sides of the lands 19 of the collet 3 and consequently block the collet 3 from being removed from the chuck 2. If the collet 3 is to be removed from the chuck 2 again, the bayonet ring 15 is put into the open position again. The removal of the collet 3 can be supported by a spring or, in general, a spring mechanism.

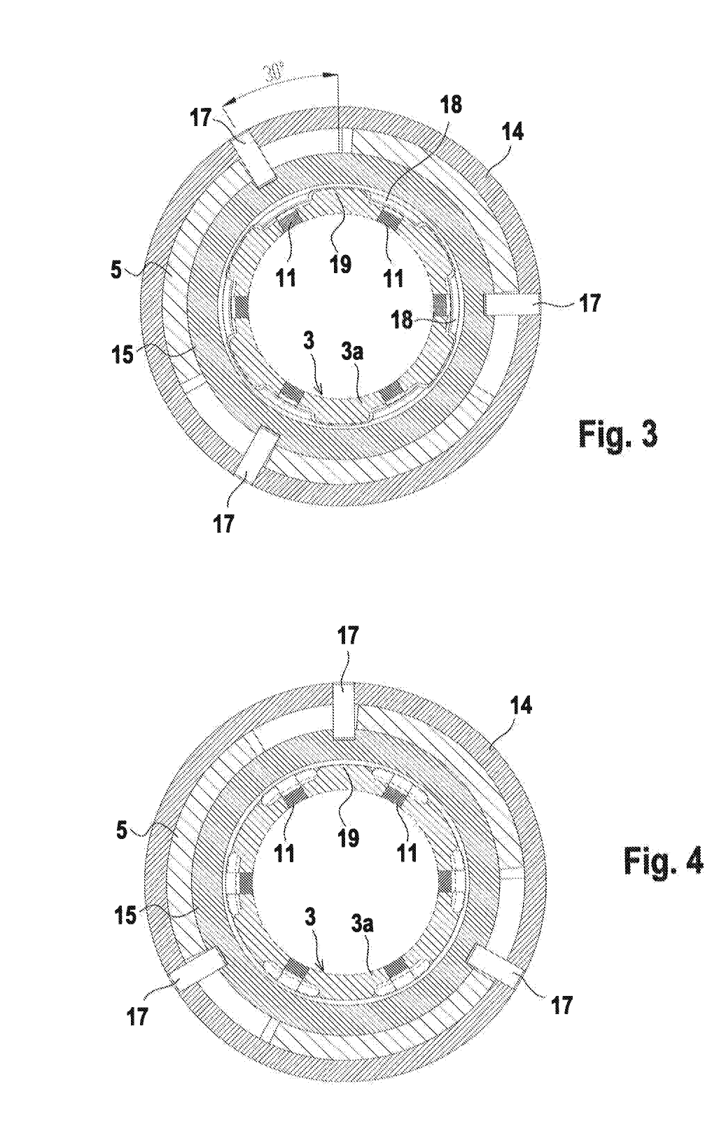

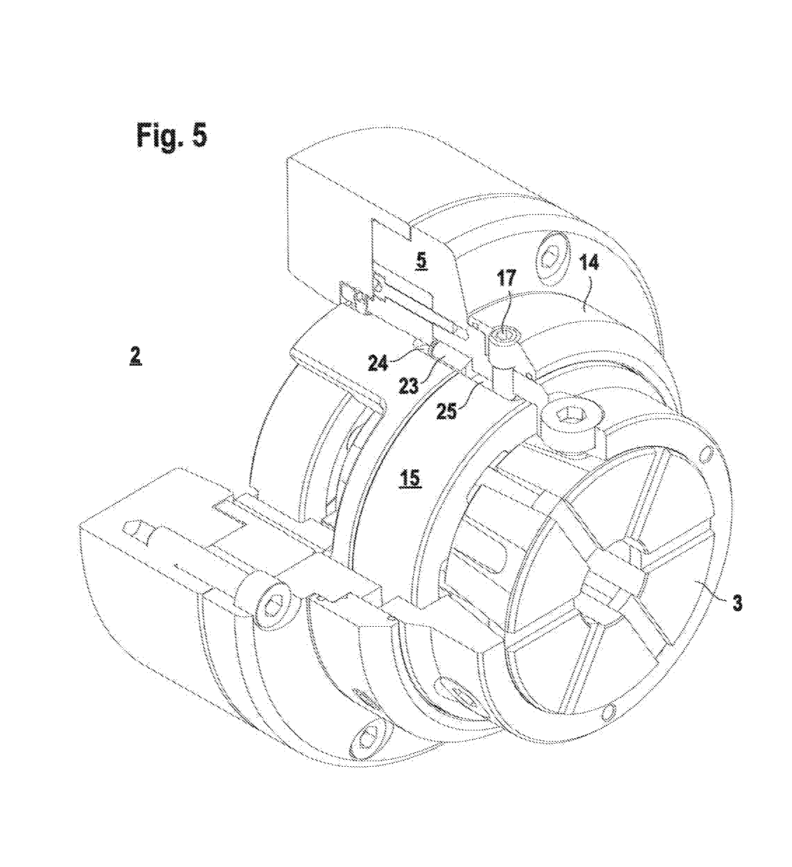

The sectional view in accordance with FIG. 3 shows the bayonet ring 15 in the open position, whereas the sectional view in accordance with FIG. 4 shows the bayonet ring 15 in the closed position. As is evident in FIG. 3, the lugs 18 of the bayonet ring 15 are in the open position in the area of the grooves 20 between the lands 19 of the collet 3 and consequently cover a part of the elastic elements 11. In the closed position shown in FIG. 4, the lugs 18 are moved in front of the lands 19 and are therefore no longer visible in FIG. 4, but the elastic elements 11 are now uncovered.

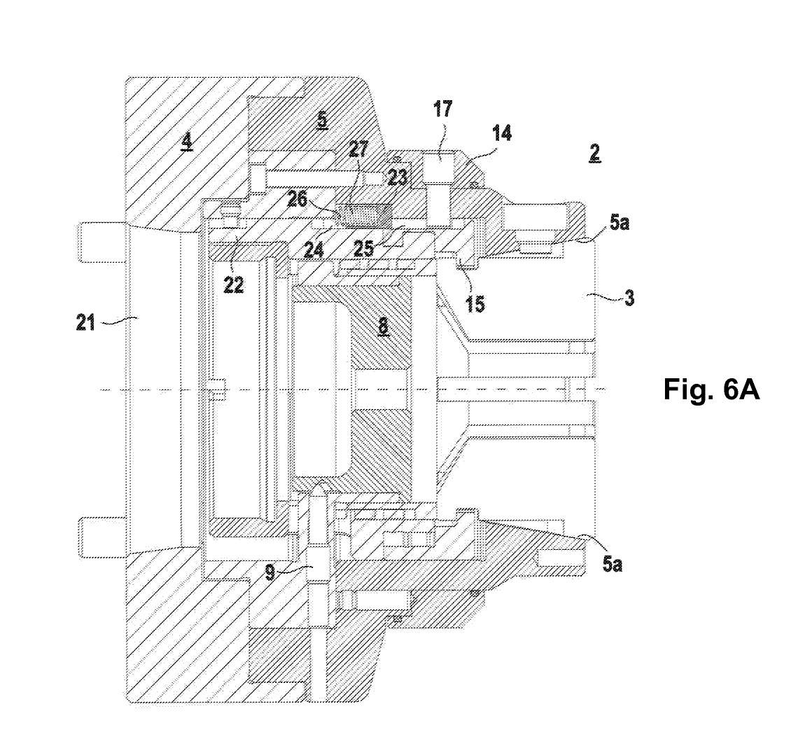

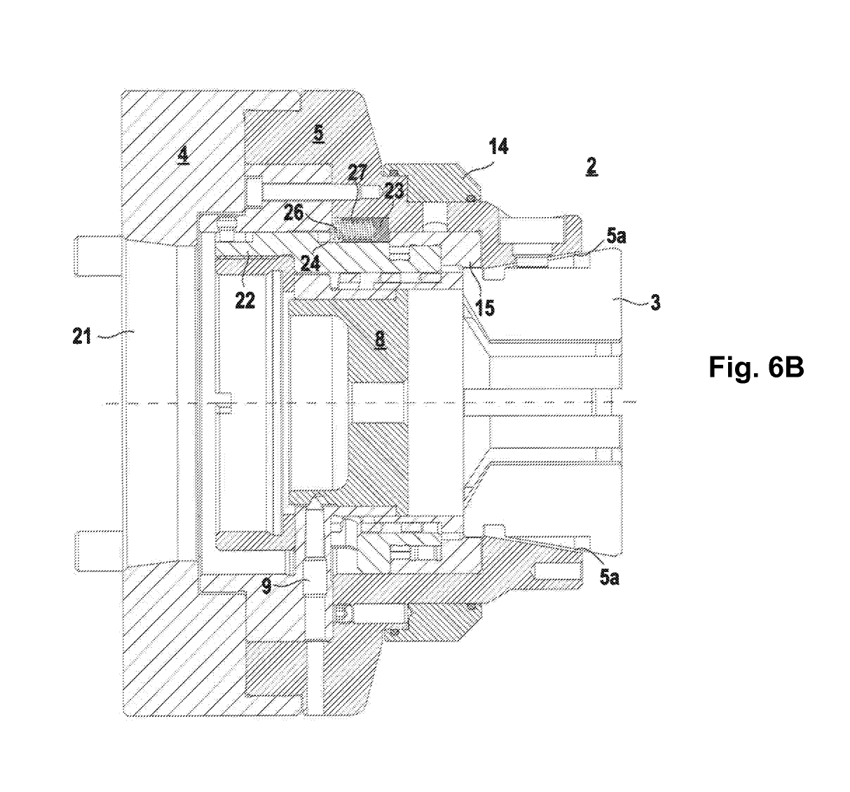

FIGS. 5, 6a and 6b show an example of the clamping device 1 as per the invention. This clamping device 1 corresponds to a great extent in terms of its structure to the embodiment of the clamping device 1 in accordance with FIGS. 1 to 4. Accordingly, corresponding components in FIGS. 5, 6a and 6b, on the one hand, and components in FIGS. 1 to 4, on the other hand, are labeled with the same reference numerals.

FIG. 6a shows the clamping device 1 when the collet 3 has moved into its clamped position in which it clamps an unshown workpiece or tool and fixes it in place. FIG. 6b shows the collet 3 in its release position in which it releases the workpiece or tool. A clamping sleeve 21 that is connected to the bayonet ring 15 via a clamping part 22 is provided to move the collet 3 between the clamped position and the release position; in its closed position, the bayonet ring 15 fixes the collet 3 in place. A linear movement of the clamping sleeve 21 is transferred via the clamping part 22 to the bayonet ring 15 and the collet 3, so the bayonet ring 15 and the collet 3 are moved vis-a-vis the fixed part of the chuck 2, in particular the chuck body 5.

The linear movement to move the collet 3 from the release position into the clamped position and vice versa takes place in a proper fashion, meaning when the bayonet ring 15 is in its closed position in an error-free case. FIGS. 5, 6a and 6b show this situation.

Moreover, these figures show a locking element 23 via which the bayonet ring 15 is protected against an unintentional release from the closed position and an uncontrolled removal of the workpiece from the collet 3 is avoided because of that.

A locking element 23 is in fact visible in the figures, but a total of three locking elements 23 with an identical design are provided that are each offset 120° vis-a-vis one another in the circumferential direction of the chuck 2.

Each locking element 23 is situated in the chuck body 5, which forms a fixed part of the chuck 2.

As is evident in FIG. 5, in particular, the locking element 23 projects into a groove 24 of the clamping part 22. A groove 25 in the bayonet ring 15, which is flush with the groove 24 of the clamping part 22, connects to the groove 24 of the clamping part 22 in the closed position of the bayonet ring 15.

As evident from FIGS. 6a and 6b, the locking element 23 has the shape of a sleeve. The longitudinal axis of the sleeve runs in the axial direction of the chuck 2. The face of the sleeve turned toward the bayonet ring 15 is closed. The face of the sleeve turned away from the bayonet ring 15 is open. A spring element 26 projects into the hollow area of the sleeve through this opening; the rear part of the spring element 26 is supported on the chuck body 5.

The functional principle of the locking mechanism formed by the locking element 23 in the error-free case shown in FIGS. 5, 6a and 6b is that the bayonet ring 15 is rotated into its closed position after the insertion of a workpiece in the collet 3; the collet 3 is fixed in place on the chuck 2 because of that. To fix the workpiece in place, the collet 3 is moved via the clamping sleeve 21 from the release position shown in FIG. 6b to the clamped position shown in FIG. 6a. The bayonet ring 15 is also simultaneously locked with this movement, because it is moved along with the collet 3, so the groove 25 in the bayonet ring 15 is in the area of the locking element 23 in the clamped position of the collet 3, meaning the locking element 23 projects into the groove 25. The bayonet ring 15 is protected against unintentional opening because of that.

When there is faulty operation, the bayonet ring 15 could be incorrectly closed before the collet 3 is moved into the clamped position. In that case, the groove 25 of the bayonet ring 15 is no longer flush with the groove 24 in the clamping part 22 in which the locking element 23 is guided. When the collet 3 is moved into the clamped position, the solid material of the bayonet ring 15 therefore hits the locking element 23 and no longer the groove 24. If the locking element 23 were rigidly situated in the chuck body 5, the impinging bayonet ring 15 would axially shear off the locking element 23, meaning destroy it. But because the locking element 23 is spring-mounted via the spring element 26, the locking element 23 can evade the bayonet ring 15 and is therefore protected in that way against damage.

The embodiment of FIGS. 5, 6a and 6b also has an enhancement vis-a-vis the clamping device 1 of FIGS. 1 to 4 in that a spring 27 is provided in the area of the clamping part 22. This spring 27 forms an ejection mechanism that causes the collet 3 to be ejected or at least released from the jaws after the release of the bayonet ring 15, which makes the removal of the collet 3 easier.

### LIST OF REFERENCE NUMERALS

(1) Clamping device
(2) Chuck
(3) Collet
(3a) Collet segment
(4) Chuck flange
(5) Chuck body
(5a) Jaw
(6) Cylinder head screw
(7) Limit stop holder
(8) Replaceable limit stop
(9) Clamping pins
(10) Sealing ring
(11) Elastic element
(12) Groove
(13) Cylinder head screw
(14) Actuation ring
(15) Bayonet ring
(16) Groove
(17) Pin
(18) Lug
(19) Lands
(20) Groove
(21) Clamping sleeve
(22) Clamping part
(23) Locking element
(24) Groove
(25) Groove
(26) Spring element
(27) Spring

1. Clamping device (1) for clamping a workpiece with a chuck (2) and a collet (3) situated in the chuck (2), wherein a bayonet closure is provided via which the collet (3) can be secured in the chuck (2) or released from it without tools, and wherein the collet (3) can be moved between a clamped position and a release position against a fixed part of the chuck (2), characterized in that at least one locking element (23) is situated in the fixed part of the chuck (2) that secures the bayonet closure against being released in the clamped position and that releases the bayonet closure for actuation in the release position.

2. Clamping device according to claim 1, characterized in that the bayonet closure has a manually operated actuation ring (14) and a bayonet ring (15) actively connected to the actuation ring (14) via which the collet (3) can be fixed in place in the chuck (2) and that in the clamped position the at least one locking element (23) blocks the bayonet ring (15) against twisting and in the release position the at least one locking element (23) releases the bayonet ring (15).

3. Clamping device according to claim 2, characterized in that the bayonet ring (15) with the collet (3) is moved between the release position and the clamped position.

4. Clamping device according to claim 2, characterized in that in the clamped position the at least one locking element (23) engages in a groove (25) of the bayonet ring (15).

5. Clamping device according to claim 1, characterized in that three identical locking elements (23) are provided that are offset in the circumferential direction by 120° vis-a-vis one another in each case.

6. Clamping device according to claim 2, characterized in that, via rotation of the actuation ring (14), the bayonet ring (15) can be moved between a closed position in which the bayonet ring (15) fixes the collet (3) in place in the chuck (2) and an open position in which the bayonet ring (15) releases the collet (3) in the chuck (2), wherein the locking element (23) or each locking element is only assigned in the closed position of the bayonet ring (15) to the respective groove (25) in such a way that the locking element (23) can move into the groove (25) when the collet (3) is moved into the clamped position.

7. Clamping device according to claim 1, characterized in that the locking element (23) or each locking element is spring-mounted via a spring element (26), wherein the locking element (23) is pressed in the direction of the groove (25) of the bayonet ring (15) via the spring force exerted by the spring element (26) when the bayonet ring (15) is in its closed position in the clamped position of the collet (³).

8. Clamping device according to claim 7, characterized in that, in the case that the bayonet ring (15) is not in the closed position in the clamped position of the collet (3), the bayonet ring (15) presses the locking element (23) or each locking element against the spring force into a safety position in the fixed part of the chuck (2).

9. Clamping device according to claim 7, characterized in that the locking element (23) or each locking element is designed in the form of a sleeve that has an opening on its face through which the spring element (26) is moved into a hollow space of the sleeve.

10. Clamping device according to claim 1, characterized in that the chuck (2) has a chuck body (5) as a fixed part in which the locking element (23) or each locking element is situated.

11. Clamping device according to claim 1, characterized in that a clamping sleeve (21) is provided via which the collet (3) can be moved between the release position and the clamped position.
